(19) United States
(12) Patent Application Publication
(10) Pub. No.: US 2021/0149354 A1
(43) Pub. Date: May 20, 2021

(54) SYSTEMS AND METHODS FOR DELAYING A DOWNWARD CYCLE OF AN ALTERNATING CURRENT POWER SIGNAL

(71) Applicant: Stellar Smart Energy Solutions, LLC, Eagle Mountain, UT (US)

(72) Inventor: Gary Bret Millar, Highland, UT (US)

(73) Assignee: Stellar Smart Energy Solutions, LLC, Eagle Mountain, UT (US)

(21) Appl. No.: 16/950,530

(22) Filed: Nov. 17, 2020

Related U.S. Application Data
(60) Provisional application No. 62/937,446, filed on Nov. 19, 2019.

(51) Int. Cl. G05B 19/042; H04L 29/08; H05B 45/30

(52) U.S. Cl. CPC G05B 19/042; G05B 2219/2639; H05B 45/30; H04L 67/12

(57) ABSTRACT

Systems, devices, and methods include a controller and a power unit coupled to a load device. The controller receives an altered AC signal, the altered AC signal comprising delays within an AC signal during a downward portion of a positive half cycle of the AC signal, determines a message from the delays within the altered AC signal, determines an action to execute based on the message, determines whether the delays present within a portion of the altered AC signal include a rising type delay, in response to determining the presence of the rising type delay in the altered AC signal, causes the power unit to introduce voltage within the altered AC signal transforming the portion of the altered AC signal including the rising type delay into a conditioned power signal, and transmits the altered AC signal or the conditioned power signal to the load device based on the action.

### CROSS-REFERENCE TO RELATED APPLICATIONS

This application claims the benefit of U.S. Provisional Application No. 62/937,446 filed on Nov. 19, 2019, the entirety of which is hereby incorporated by reference.

### TECHNICAL FIELD

Embodiments described herein generally relate to systems and methods for customized lighting and communication via alternating current power and, more specifically, to providing a communication protocol and related hardware and software for customized lighting controls utilizing the downward cycle of an alternating current (AC) signal that reduce negative effects of delays in the altered AC signal.

### BACKGROUND

As lighting and power technologies have developed, there is now a desire to provide and/or utilize energy efficient electric and electronic devices. As an example, the lighting industry consumes a large amount of power and there is constantly pressure to reduce costs and reduce grid usage via more efficient lighting devices. It is also often difficult to adequately control lighting or segments of lighting devices at a desired power level, wavelength, or intensity. Such control customarily requires dedicated power lines to run to each segment of the lighting device and in some instances a separate control line.

As such, there is a need to reduce the need for a separate control line and provide a lighting system capable of receiving power and communication protocols simultaneously.

### SUMMARY

In some embodiments, a system and method for delaying a downward cycle of an alternating current power signal to control the operation of a load device, the system includes a first device and a second device in communication. The first device is configured to selectively introduce one or more delays within an alternating current (AC) signal during a downward portion of a positive half cycle of the AC signal thereby generating an altered AC signal, and transmit the altered AC signal to a second device. The second device is configured to receive the altered alternating current power signal, determine a message from the coded communication within the altered AC signal, determine an action to execute based on the message, and transmit the altered AC signal to a load device based on the message and when the AC signal does not include a delay in a portion of the altered AC signal that is not the downward portion of a positive half cycle of the AC signal.

In some embodiments, a system utilizing one or more delays in downward cycles of an alternating current power signal to control the operation of a load device is disclosed. The system includes a controller comprising a load computing device and a power unit and the controller is electrically coupled to the load device. The controller is configured to receive an altered AC signal, the altered AC signal comprising one or more delays within an alternating current (AC) signal during a downward portion of a positive half cycle of the AC signal, determine, at the load computing device, a message from the one or more delays within the altered AC signal, determine an action to execute based on the message, determine whether the one or more delays present within a portion of the altered AC signal include a rising type delay, in response to determining the presence of the rising type delay in the altered AC signal, cause the power unit to introduce voltage within the altered AC signal transforming the portion of the altered AC signal including the rising type delay into a conditioned power signal, where the conditioned power signal reduces the rising type delay, and transmit the altered AC signal or the conditioned power signal to the load device based on the action determined from the message.

In some embodiments, a method of utilizing one or more delays in downward cycles of an alternating current power signal to control the operation of a load device is disclosed. The method includes receiving, with a second device, an altered AC signal; determining, with the second device, a message from the one or more delays within the altered AC signal; determining, with the second device, an action to execute based on the message; determining, with the second device, whether the one or more delays present within a portion of the altered AC signal include a rising type delay; in response to determining the presence of the rising type delay in the altered AC signal, causing a power unit to introduce voltage within the altered AC signal transforming the portion of the altered AC signal including the rising type delay into a conditioned power signal, where the conditioned power signal reduces the rising type delay; and transmitting the altered AC signal or the conditioned power signal to the load device based on the action determined from the message.

In some embodiments, a device for providing delaying a downward cycle of an alternating current power signal to control the operation of a load device is disclosed. The device includes a processor and a memory component. The memory component includes logic that, when executed by the processor, causes the device to receive an altered AC signal, the altered AC signal comprising one or more delays within an alternating current (AC) signal during a downward portion of a positive half cycle of the AC signal, determine, at the load computing device, a message from the one or more delays within the altered AC signal, determine an action to execute based on the message, determine whether the one or more delays present within a portion of the altered AC signal include a rising type delay, in response to determining the presence of the rising type delay in the altered AC signal, cause a power unit to introduce voltage within the altered AC signal transforming the portion of the altered AC signal including the rising type delay into a conditioned power signal, wherein the conditioned power signal reduces the rising type delay, and transmit the altered AC signal or the conditioned power signal to the load device based on the action determined from the message.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts a power and communications network, according to embodiments shown and described herein;

FIG. 2 depicts a signal generator, according to embodiments shown and described herein;

FIGS. 3A-3B depict waveforms of AC signal that may be altered by the signal generator, according to embodiments shown and described herein;

FIG. 4 depicts a lighting device, according to embodiments shown and described herein;

FIG. 5 depicts a flowchart for sending altered AC signal to a device, according to embodiments shown and described herein;

FIG. 6 depicts a flowchart for determining contents of a message that was sent via altered AC signal and controlling the load device based on the action determined from the contents of the message, according to embodiments shown and described herein; and

FIG. 7 depicts a load computing device for determining a characteristic of AC signal, according to embodiments shown and described herein.

### DETAILED DESCRIPTION

Embodiments of the present disclosure relate to systems and methods for providing customized devices utilizing communication provided via an alternating current (AC) signal where delays introduced in the alternating current power signal control the functionality of a lighting source such as an LED or other electrical device. More specifically, a system may include a first device, which receives the AC signal. The first device introduces a delay in the AC signal before and/or during the zero crossing, thereby generating an altered AC signal. The first device is further configured to introduce the delay during a falling portion of the AC signal (i.e., when the AC signal is transitioning from a peak value to a zero value). By introducing a delay in the AC signal before a zero-crossing occurs and during the falling portion (i.e., a high to low transition) of the AC signal, undesired performance of the load device may be avoided. For example, in some instances when power is provided to a load device during a low to high transition (e.g., a low voltage to high voltage or low current to high current value) and a portion of the AC signal from a low level to a middle level voltage or current value during the transition was delayed (i.e., effectively zero voltage and zero current is provided to the load during the delay), the sudden influx of a mid-level or high level voltage or current value supplied to a load device causes either instantaneous damage and/or long term degradation of the load device. In other words, instantaneous peak or near peak applications of voltage and/or current to some electronic devices such as LED lighting devices and their control circuitry cause either immediate or latent damage.

In embodiments of the present disclosure, once the first device generates the altered AC signal, the first device outputs the altered AC signal. A second device receives the altered alternating current power signal and determines the presence of a communication signal, for example, based on the number of consecutive delays present within the altered AC signal, the length of delays, and/or sequence of delays and/or full cycles. The second device may be an LED lighting device, motor drive system, or other device configured to operate on power from a power source and receive control signals via the power from the power source. In some embodiments, this communication signal may correspond to a command to transmit the altered AC signal to a load device to power the load device, adjust the wavelength of the light output by the load device, reverse, start, or stop the functionality of the load device, and/or the like which may include any command to alter the state of a load device.

The second device may include zero-crossing detection circuitry, timer circuitry, one or more switching devices, and/or other components for receiving the altered AC signal and selectively connecting, disconnecting, or otherwise controlling a power signal supplied to the load device. In some embodiments, the initial unaltered AC signal may be a rectified AC signal. As such, the first device may utilize additional positive voltage and/or current cycles to implement a delay and thereby a coded communication signal.

In some embodiments, the second device or the load device may include circuitry to detect whether the AC signal, which is to be supplied by the second device or being received by the load device, is transitioning from a low to high value. That is, when a low to high transition is detected and activation of the load device is to occur, the second device may delay activating the load device. In some instances, the load device may delay activating itself to avoid a surge or sudden step-up in power to the load device. By detecting such a transition and not activating the load even though a control signal may indicate that a load should be activated, the load may be protected from undesired operation or damage.

Additionally included herein are embodiments for customized load control. One embodiment of a method includes receiving an altered AC signal, where the altered AC signal is altered via inclusion of a delay to communicate a message, converting the message in the altered AC signal into a computer-readable format, and determining an action to take related to the message. Some embodiments include utilizing the altered AC signal for powering a load or performing an action, based on the message.

Embodiments of an electric device include an alternating current filter for filtering an altered AC signal to create a filtered signal. Embodiments may also include a power unit for utilizing the altered AC signal to cause the load to perform an action and a load computing device that stores logic that, when executed by a processor, causes the electric device to receive the filtered signal from the alternating current filter. In some embodiments, the logic causes the electric device to determine, from the filtered signal, a message included in the altered alternating current power, where the message is configured as a plurality of delays before and/or around respective zero cross points of the altered alternating current power. In some embodiments, the logic causes the electric device to determine from the message, the action for the load to take and further causes the electric device to communicate an instruction related to the action to the power unit, where the power unit utilizes the instruction to convert the altered AC signal to implement the action.

Also included are embodiments of a system. The system may include a power unit for utilizing an altered AC signal to cause the load perform an action and a load computing device that stores logic that, when executed by a processor, causes the electric device to receive the altered AC signal. The altered AC signal includes a message that may be transmitted at the same frequency as the altered AC signal. The message is configured as one or more delays around a zero cross point of the altered alternating current power. In some embodiments, the logic further causes the system to determine, from the message, the action for the load to take and communicate an instruction related to the action to the power unit, where the power unit utilizes the instruction to convert the altered AC signal for the load to implement the action.

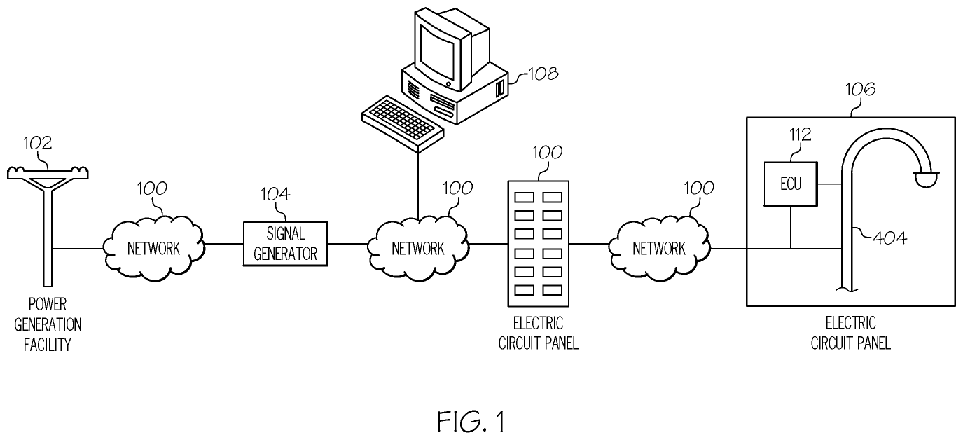

Referring now to the drawings, FIG. 1 depicts a power and communications environment, according to embodiments described herein. As illustrated in FIG. 1, the power and communications environment may include a network 100, which is coupled to a power generation facility 102, a signal generator 104, a lighting device 106 (e.g., also referred to herein as the second device) and/or other electric device, and a remote computing device 108. The network 100 may include a power network, which may include alternating current power that is delivered to a one or more devices (or loads). The network 100 may also include a communications network, such as a wide area network, (e.g., the Internet, a cellular network, a telephone network, etc.) and/or a local area network (e.g. an Ethernet network, a wireless fidelity network, a near field communications network, etc.). As will be understood, the network 100 between any two devices may include a single wire or communication link and may include a plurality of power and/or communications channels.

The power generation facility 102 is also included in the embodiments of FIG. 1 and may include a power plant, a solar power generation network, a power storage facility and/or other facility that facilitates the generation and/or distribution of power to one or more devices. As will be understood, the power generation facility 102 may be configured to create and/or provide power in the form of an AC signal (also referred to herein as “AC power”). It should be understood that while the power generation facility 102 described herein may create the AC power, some embodiments may include separate entities and/or facilities for creating, storing, and transmitting the AC power to the devices, which are all included in the power generation facility 102 for simplicity.

Also included in FIG. 1 is the signal generator 104. The signal generator 104 may be configured to receive the AC power, as well as a communication signal, for example, from a computing device or electronic controller. As described in more detail below, the signal generator 104 may additionally alter the AC power on the same frequency that the AC power was received to embed a message into the AC power. The communication signal transmitted to and received by the signal generator 104 may be a digital or analog communication signal using any known data communication protocol and structure. In some embodiments, the signal generator 104 may include an AC controller computing device 204 having a processor 204A and memory 204B that is configured to generate an original message for communication. The signal generator 104 converts the digital or analog communication signal into the communication protocol and structure for embedding and transmitting within an altered AC signal.

The lighting device 106 may operate in concert with or separate from the signal generator 104 and may be configured to receive AC power from the power generation facility 102 for performing a function (such as illuminating a light emitting diode (LED)). The lighting device 106 may additionally receive a message from a computing device that is transmitted via the signal generator 104 or directly from the signal generator 104, which may include a control command message to alter the function of the lighting device 106, facilitate monitoring of a function of the lighting device 106, and/or perform other actions. Some other actions may include adjusting the wavelength, intensity, direction, or the like of the light output by the lighting device 106.

It should be understood that while the lighting device 106 is described herein as an LED illumination device; this is merely an example. While embodiments described herein relate to illumination, this description may extend to other electric or electronic devices including but not limited to motors, solenoids, displays, switches, or the like. Accordingly, any load may be attached to the hardware and/or software described herein to provide a desired functionality.

Also included in FIG. 1 is a remote computing device 108. The remote computing device 108 may represent one or more computing devices that may facilitate sending messages and/or commands to be included in AC power. The remote computing device 108 may also be configured for updating software and/or firmware associated with the components, and/or provide other functionality. As an example, some embodiments may be configured to receive a command from the remote computing device 108 to activate the lighting device 106. This command may be sent via a communications network (which is part of the network 100) to the signal generator 104, which may convert the message to be communicated via an altered form of the AC power. The AC power may be received by the lighting device 106, which may also receive the message. The lighting device 106 may thus be powered by the altered AC signal and receive communications via the altered AC signal. In some embodiments, the lighting device 106 may include or be communicatively coupled to an electronic controller unit (“ECU”) 112 (e.g., also referred to as a controller) configured to extract the message from the altered AC signal and control the load device according to the message. For example, the message may be an instruction to activate or deactivate a load, an instruction to increase or decrease the intensity, an instruction to change the output wavelength, and/or the like.

The signal generator 104 with an electric circuit panel 110, such as a breaker panel, may or may not be co-located with the signal generator 104. For example, the power generation facility 102 may provide AC power to a user's facility, which may be received at the electric circuit panel 110 controlling operation and/or for distribution along a local portion of the network 100 to various loads at the user's facility. However, the signal generator 104 may be included with the electric circuit panel 110 and/or provided at the user premises and coupled to the electric circuit panel 110 via a local network to provide user control of the desired functionality. Depending on the particular embodiment, the signal generator 104 may be included in series between the power generation facility 102 and the electric circuit panel 110. However, some embodiments may be configured with the electric circuit panel 110 between the power generation facility 102 and the signal generator 104. Other configurations may also be utilized, depending on the embodiment. Regardless, the lighting device 106 may be coupled to the circuit for receiving power from the power generation facility 102.

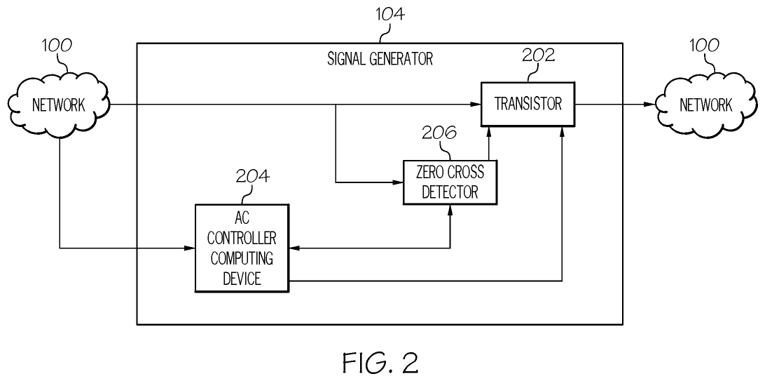

FIG. 2 depicts a signal generator 104, according to embodiments described herein. As illustrated, the signal generator 104 may include a transistor 202, an AC controller computing device 204, and a zero cross detector 206. In some embodiments, the signal generator 104 may include a relay. That is, while the signal generator 104 is described with reference to a transistor 202, the transistor 202 may be a relay such as a solid state relay. The signal generator 104 may receive AC power from the power generation facility 102 at the transistor 202 and the zero cross detector 206. The signal generator 104 may also receive a communication signal such as from the remote computing device 108 at the AC controller computing device 204. The AC controller computing device 204 may determine a message that was sent via the communication signal and may determine an action to take from the communication signal. As an example of an action, the communication signal may request that the lighting device 106 be turned OFF, turned ON, dimmed, brightened, change color, and/or the like. Accordingly, the AC controller computing device 204 may determine this request from the communication signal and then determine how and when to alter the AC power that is received by the transistor 202 so that the AC power may be altered to communicate the message over the same frequency as the AC power.

In order to communicate the communication signal over the AC power, the AC controller computing device 204 may determine a communications protocol. As an example, the communications protocol may include delaying transmission and/or inserting a standard delay time at predetermined intervals in the AC power. Depending on the timing of the plurality of delays, a recipient device may decode the communication. As another example, the AC controller computing device 204 may determine the length of delay for communicating the message. The length of each delay may have a different representation, such as a character, control command, or other meaning. In this scenario, the length of delay and timing of subsequent delays may provide the communications protocol for the recipient device to decode. Based on the determined communication protocol that is being used, the zero cross detector 206 may determine when the AC power is transmitting zero volts (e.g., when the voltage from the AC power changes from positive to negative, or vice versa). In some embodiments, the zero cross detector 206 may determine when the amplitude of a rectified signal is decreasing and approaching a zero value and then suddenly increases. As used herein, “the zero cross point” refers to a point where the AC power crosses zero volts, either from positive to negative or from negative to positive. The AC controller computing device 204 may insert an alteration into the AC power, such as a delay. The delay may be implemented by causing the transistor 202 to switch from a conduction state to a non-conduction state for a period of time during a downward portion of a positive cycle of the AC signal. In some embodiments, the zero cross detector 206 may cause the transistor to return to a conduction state when the voltage and/or current of the AC power monitored by the zero cross point begins to increase again after a zero crossing. As such, a delay in the altered AC signal may not extend into the rising portion of the altered AC signal so that the load device may be protected from the potential of a sudden insertion of voltage or current that could damage the load device. The alteration may occur at or around one or more zero cross points of the AC power and may be configured as a binary signal, for example and without limitation, a delayed zero cross point (e.g., a zero cross point that remains at or near zero volts for longer than normal) indicates a binary “1” and a non-delayed zero cross point indicates a binary “0.” Other formats and protocols may be used as well, such as different lengths of delay to indicate different characters of a message. The transistor 202 may then implement the desired alteration to the AC power, which is sent along the network 100.

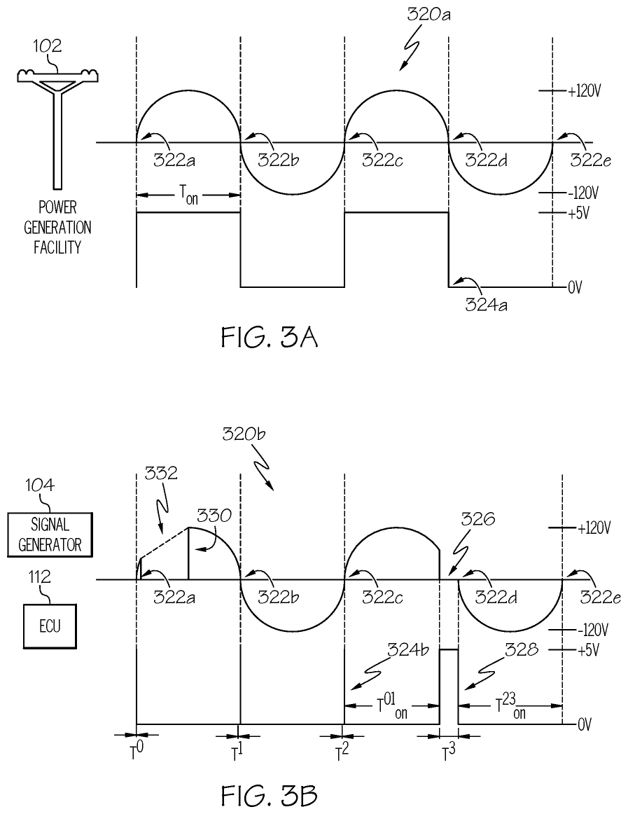

FIGS. 3A-3B depict waveforms of AC power that may be altered by the signal generator 104, as described herein. Specifically, FIG. 3A depicts a waveform 320a of AC power generated by a power generation facility 102. The AC power may be used for powering one or more devices. The AC power may be transmitted with a peak voltage of plus/minus 120 volts, 220 volts, 440 volts, and/or other voltages. Accordingly, between the positive and negative peaks are zero cross points 322a-322d (collectively referred to as zero cross points 322), where the voltage approaches zero and/or is zero.

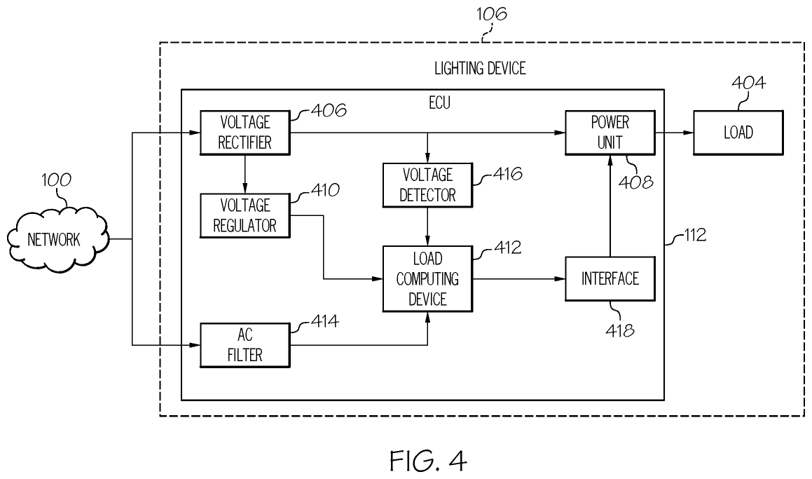

Also depicted in FIG. 3A is a square wave 324a, with a voltage range of 0 volts to 5 volts. As described in more detail with regard to FIG. 4, the square wave may be created from the AC power via an AC filter 414 (FIG. 4) such that the load computing device 412 (FIG. 4) may be adequately powered. As will be understood, the voltage range of the square wave 324a may vary, depending on the requirements and specifications of the load computing device 412.

FIG. 3B depicts a waveform of an altered AC signal 320b that has been altered by the signal generator 104 to communicate a message, as described herein. Specifically, the waveform of the altered AC signal 320b may be similar to the waveform 320a, except altered to communicate the message. Accordingly, the waveform of the altered AC signal 320b may have predetermined positive and negative voltages, as well as zero cross points corresponding with the waveform 320a. Additionally, the waveform of the altered AC signal 320b may have a predetermined half period (represented as “T⁰¹ₒₙ”) which also corresponds to the half period (represented as “Tₒₙ”) of waveform 320a. Upon determining the substance of a message to be sent, the signal generator 104 may be configured to delay (i.e., bring the voltage of the AC signal to zero volts or close thereto) transmission of the AC power during a decreasing portion of the AC signal before and/or up to a zero cross point 322 for a predetermined time period before continuing the transmission.

Some embodiments of the present disclosure assure the communication signals embedded with the AC power occur during intervals of the AC power that do not negatively impact the operation, stability, or life cycle of the load device which ultimately receives the altered AC signal as a source of power. As discussed above, AC signals that include spikes in the OFF to ON power, leads to irreversible damage to load devices. For example, OFF to ON power that is a non-sinusoidal increase or ramp up portion, for example, having an instantaneous increase from, for example, 0 volts to 50 volts or more is damaging to a load device. The instantaneous increase in the voltage or current of the AC signal that can result in damage to load devices may be any instantaneous step up in voltage or current from 0 volts to the peak voltage of the AC signal or any values therebetween.

Therefore, introducing a delay used for embedding a communication into an AC signal that is also provided as power to the load should be implemented in a downward trend of the AC signal and stop at or around the zero cross point of the AC signal. Moreover, a system for implementing a delay in the downward trend of the AC signal cannot be implemented through conventional means such as through the use of a TRIAC device or similar device. That is, a TRIAC device is only capable of implementing a delay in the first half of a positive cycle of the AC signal. As such, embodiments described herein include a system, for example, as described herein which implements a delay used for embedding a communication into an AC signal that is also provided as power to the load should be implemented in a downward trend of the AC signal and stop at or around the zero cross point of the AC signal.

As illustrated in FIG. 3B, the signal generator 104 generates the altered AC signal 320b depicted as a waveform in FIG. 3B. A delay 326 in the AC signal is introduced in the downward trending portion of the AC signal of the second positive cycle that is depicted in FIG. 3B. In some embodiments the signal generator 104 generates the delay 326 by monitoring the time from a previously occurring and detected zero cross point 322. As an example, assuming that the present AC signal has a frequency of 60 Hz and a peak voltage of 120 volts. Therefore, one cycle of the AC signal occurs every 1/60 of a second or about every 16.67 ms. A half cycle occurs every 0.5/60 of a second or about every 8.33 ms and a quarter cycle occurs every 0.25/60 of a second or about every 4.167 ms. Additionally, the signal generator 104 includes components and/or processes for detecting the voltage level of the AC signal. Through detecting the voltage level of the AC signal the signal generator 104 may track the voltage levels over time and determine whether the AC signal is increase in value or decreasing in value. Additionally, the signal generator 104 is configured to detect a zero cross point 322.

In some embodiments, the signal generator 104 may determine when the AC signal is in a positive half cycle through a voltage value sensed by an A/D convertor or similar means that detects the polarity of the AC signal. The signal generator 104 may then determine, for example, through a timer circuit, when a quarter half cycle of time has passed from the last detected zero cross point. The signal generator 104 may then implement a delay 326 of a predefined length any time after the initial quarter half cycle, which would be the downward portion of the positive half cycle. As used herein, “downward” refers to the portion of an AC signal where the voltage and/or current of an AC signal transitions from a peak value to a zero or near zero value. This may be from positive values to zero or negative values to zero.

In some embodiments, the length of the delay 326 during the downward portion of the positive half cycle may indicate a particular value of a communication protocol and when one or more delays 326 are sequentially combined with non-delayed cycles of the AC signal a corresponding message may be determined. In other embodiments, the mere presence of a delay 326 (i.e., have a zero voltage or near zero voltage value) may indicate a “0” or “1” value.

The altered AC signal transmitted from the signal generator 104 to the recipient device such as a load device and/or an ECU 112. The ECU 112 is configured to receive the altered AC signal and determine and extract the communicated message from the altered AC signal. The ECU 112 may include a zero cross point detection circuit, for example, enabled through an A/D convertor configured to monitor the voltage or current value of the AC signal. FIG. 3B further depicts a waveform 324b generated by the ECU 112 when detecting the zero cross points of an AC signal. As depicted, when the ECU 112 detects a zero cross point a corresponding voltage pulse may be triggered. When the zero cross point occurs during an unaltered cycle of the AC signal, the voltage pulse has a pulse width T⁰, T¹, or T² of a trivial amount of time, for example, about 100 μs or 10 μs or 1 μs, depending on the frequency of the AC signal. However, when a delay 326 is present in the altered AC signal the voltage pulse 328 (i.e., the detected zero value of the altered AC signal) will be greater than the trivial amount of other voltage pulses where no delay is present. For example, the delay 326 may cause a voltage pulse to be generated by the ECU 112 having a pulse width T³, which is greater than the pulse width T⁰, T¹, or T². In a 60 Hz AC signal, the pulse width T³ may be about 4.167 ms or less, but greater than the pulse width T⁰, T¹, or T² of a zero cross point of an unaltered cycle of the AC signal. The greatest value of the pulse width T³ depends on the frequency of the AC signal and is generally no more than the period of a quarter half cycle of the AC signal.

As stated above, detection of the delay indicates the presence of a communication embedded in the AC signal that is also used for powering a load device such as a lighting device. The ECU 112 may compile a series of the detected delays into a coded communication that may be decoded into a message such as an instruction for controlling a load device. Depending on the protocol being implemented, the recipient device may decode the message and react appropriately. In some embodiments, a delayed waveform at or around an expected zero cross point will be identified as a binary “1,” while an unaltered zero cross point of the AC power may represent a binary “0” (or vice versa). Thus, the recipient device (e.g., the ECU 112) may decode the series of binary “ones” and “zeros” to determine a message being sent via the AC power. Other embodiments may utilize a different encoding protocol, such as varying the length of delay to indicate a “1” or “0” or other data (e.g., a first amount of delay may indicate a first signal such as a “1” and a second amount of delay may represent a second signal such as a “0” and/or other coding protocol).

It should now be understood that the signal generator 104 may use one or more of these characteristics and/or detected values to determine when the AC signal is in a positive half cycle and when the AC signal is decreasing in value. The signal generator 104, depending on the message that is to be embedded within the AC signal, may implement one or more delays 326 during the downward portions of the positive half cycle of the AC signal during one or more cycles of the AC signal.

Still referring to FIG. 3B, in some embodiments a communication may be embedded using delays that are not within the downward portion of the AC signal. For example, a rising type delay 330 may be configured such that the voltage for a predetermined delay period is configured within the rising portion of the AC signal. As used herein, “rising portion” refers to portions of the AC signal, whether in the negative half or positive half cycle where the voltage level is increasing with time. Here, the rising type delay 330 will cause a rapid introduction of a high voltage and possibly a correspondingly high current in rush to the load device when the delay is complete. However, as described in more detail herein, the rising type delay 330 may be detected by the controller and the power unit 408 may introduce a power signal 332 that causes the portion of the altered AC signal having the rising type delay 330 to removed or reduced before the altered AC signal is introduced to the load device. In other words, the power signal 332 may be a voltage and current that, to the load device, appears as if the altered AC signal was providing near or the same cyclical power that an AC signal would without the rising type delay 330. The power signal 332 may be generated by the power unit 408 and may have a linear, sinusoidal, or other type of profile over the portion of the altered AC signal that includes the rising type delay 330. It should be understood that the same method for reducing and/or removing any rising type delays 330 from the altered AC signal may also be configured to reduce and/or remove other types of delays within the altered AC signal thereby transforming the altered AC signal into an analogous and non-damaging form of AC signal power that is provided to the load device.

FIG. 4 depicts an example schematic of a load device having an ECU 112 that takes the form of a lighting device 106, according to embodiments described herein. As illustrated, the lighting device 106 includes an ECU 112 and a load 404. The ECU 112 may include a voltage rectifier 406, a power unit 408, a voltage regulator 410, a load computing device 412, an AC filter 414, and an interface component 418. Specifically, the voltage rectifier 406 of the ECU 112 may receive the AC signal (or the altered AC signal, depending on the embodiment). The voltage rectifier 406 may be configured to modify the AC signal (waveform 320a or 320b from FIGS. 3A and 3B) to rectify or remove negative portions of the waveform and/or otherwise convert the AC power into direct current (DC) power. As an example, the load 404 may be configured to only activate with positive voltage. Accordingly, if the load 404 receives an unrectified AC signal, the LEDs may flicker due to the negative voltage being received. This may result in a potentially undesirable output. As such, the voltage rectifier 406 may be configured to output only non-negative voltage to provide a steady output from the load 404.

The voltage rectifier 406 may send the rectified voltage to the power unit 408, as well as to the voltage regulator 410. The power unit 408 may include a capacitor, a battery, or other electronic component or circuit configuration that is capable of collecting energy over time and emitting energy to smooth or fill excessively large gaps (e.g., delays) in the altered AC signal caused from embedded delays used for communication within the AC signal as described herein. That is, the power unit 408, in response to the determined action from the altered AC signal received by the controller, provides conditioned power to the load 404. As used herein, “conditioned power” refers to the power signal generated by the power unit 408 for powering the load 404, where the power unit 408 has conditioned the received altered AC signal by removing or reducing the presence of delays introduced as communication signals within the AC signal. For example, in some communication systems the one or more delays may be configured within portions of the AC signal that are not the downward portion of a positive half cycle of the AC signal. As disclosed herein, delays, for example, used to embed communication messages within the AC signal that are configured in a rising portion (e.g., where the voltage in a cycle of the AC signal is increasing), when applied to the load device, may cause damage or undesired performance of the load device. For example, the delay in a rising portion of the AC signal may create an AC signal profile where the voltage sharply rises from a low or no voltage state to a high voltage level (e.g., about 50, 75, 100, 120, 200, 240 volts or more). The sudden increase in voltage and possibly corresponding in rush of current to the load device such as a LED lighting device may cause the device to not perform as desired, burn out, or decrease its life cycle.

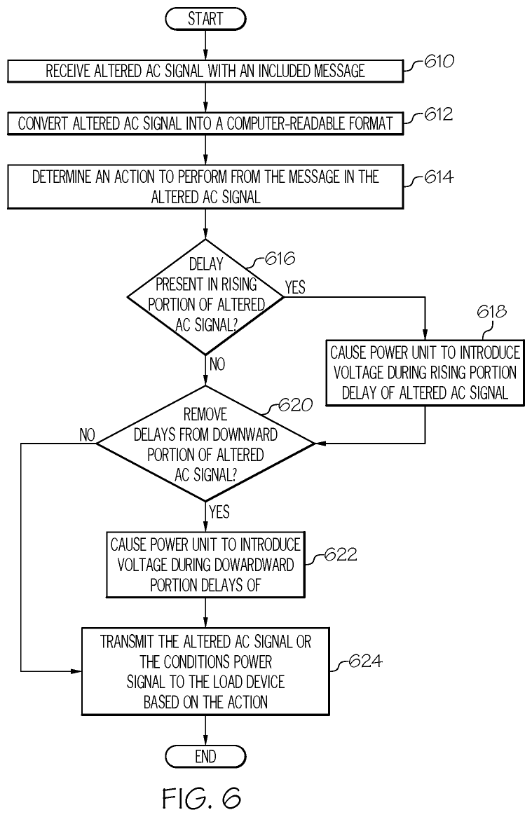

However, by implementing a power unit 408 and a control circuit that is configured to detect the presence of delays in non-downward portions of a positive half cycle of the AC signal (or elsewhere), the potentially damaging delays within the altered AC signal may be removed or reduced before the altered AC signal powers the load device. The detection and removal or reduction of the potentially damaging delays within the altered AC signal is described in more detail herein, for example, with reference to FIG. 6.

The voltage regulator 410 may be configured to reduce the voltage of the rectified power to a level that is usable to power the load computing device 412. As an example, the voltage regulator 410 may reduce the DC voltage to about 5 volts or other voltage that is usable by the load computing device 412. This converted DC voltage may be sent to power the load computing device 412.

The load computing device 412 may also be coupled to the voltage detector 416 and may be configured to alter the manner in which voltage is delivered to the load 404. Similarly, some embodiments of the load computing device 412 may be configured to receive the altered AC signal that includes communication data, decode that communication, and perform an action, based on the decoded message.

To this end, the voltage detector 416 may receive the rectified voltage from the voltage rectifier 406 and may determine a characteristic of the altered AC signal. Based on the characteristic, the load computing device 412 may send a communication to the interface component 418, which acts as a barrier between high and low voltages. The interface component 418 may send a signal to the power unit 408, which may alter the voltage received by various portions of the load 404, based on the message received in the altered AC signal and decoded by the load computing device 412. In some embodiments, the interface component 418 may monitor the altered AC signal to determine where in the cycle of the altered AC signal a delay occurs. If a delay is detected during an increasing voltage portion of the altered AC signal, the ECU 112 and/or the interface component 418 may cause the power unit 408 to disconnect from the load 404 or at least not transmit the portion of the altered AC signal having the delay in the increasing portion of the AC signal. As used herein “increasing portion” of the AC signal refers to the portion of the cycle of the AC signal that increases from a zero or near zero voltage and/or current value toward a peak voltage and/or current values. This increase may be from zero toward a positive peak or from zero toward a negative peak. As a result, the load 404 may be protected from instantaneous or rapid spikes in voltage that may result in damage and/or degradation of the load 404.

Additionally, the AC power (with the alterations described in FIG. 3B) may be received by the AC filter 414. As described above regarding FIGS. 3A and 3B, the AC filter 414 may receive the AC power and convert the AC power into a filtered signal (e.g., waveform 324b), which may include a computer-readable format, such as a square wave with a peak voltage that is compatible with the load computing device 412. If the signal generator 104 (FIGS. 1 and 2) alters the AC power (such as including a delay), the square wave produced by the AC filter 414 may also include the alteration (or similar alteration). The load computing device 412 may receive the square wave from the AC filter 414 and may utilize logic to determine the message included in the square wave. Depending on the particular embodiment, the message sent via the AC power may include an instruction to activate the load 404, deactivate the load 404, reduce power to the load, adjust the wavelength of light output by a lighting device, change direction of a motor, or etc. Some embodiments may be configured to cause the load computing device 412 to implement a test sequence for testing operation of the lighting device 106. Similarly, some embodiments may cause the load to communicate a message to another device (such as a mobile phone, television, computing device, etc.).

As an example, some embodiments may be configured such that the load is an array of light emitting diodes (LEDs). Based on the received voltage of the AC power, the load computing device 412 may cause the power unit 408 to send the AC power only to those LEDs that can properly operate under the power constraints, thus changing output of the LEDs. This can provide relatively consistent output of the load 404, regardless of the AC power.

It should also be understood that embodiments of the ECU 112 may be provided on a printed circuit board (PCB) and/or other circuit material that includes an aluminum substrate as a primary component. By utilizing an aluminum substrate for the ECU 112, heat may be dissipated, thus removing the necessity for a heat sink or other heat removal devices.

Additionally, while the embodiment of FIG. 4 depicts a single ECU 112 and a single load 404, this is also merely an example. Some embodiments may couple a plurality of loads 404 to a single ECU 112 and/or a plurality of ECUs 112 together to provide the desired functionality and/or illumination. Additionally, the blocks 202-206 depicted in FIG. 2 and blocks 406-418 from FIG. 4 may be implemented in hardware (including programmable hardware), software, and/or firmware depending on the particular embodiment, so long as the desired functionality is provided. It should also be understood that while the lighting device 106 is depicted with both the ECU 112 and the load 404, this is also an example. Some embodiments may include a device circuit that is separate from the lighting device 106.

In view of the description of each of the aforementioned components and operations thereof, the following will now describe operation of an example embodiment of the system. In embodiments, a power generation facility 102 (FIG. 1) generates an AC signal, which is also referred to herein as AC power. A signal generator 104 receives the AC signal. The signal generator 104 may be in communication with a computing device that generates a message for sending to a load device or the signal generator 104 may include such device. The signal generator 104 (aka, a first device) is configured to selectively introduce a delay during a trailing edge of a positive half cycle of the AC signal as required to transmit the message as a coded communication embedded with the AC signal. As such, an altered AC signal is generated by the signal generator 104 and transmitted to a second device, such as a load device having an ECU. The second device is configured to receive the altered AC signal and determine a message from the coded communication within the altered AC signal. Additionally, the second device determines when to transmit the altered AC signal to a load device based on the message. In some embodiments, the ECU does not transmit a portion of the AC signal having a delay during the leading edge (i.e., the increasing portion of the positive half cycle) of the AC signal. In some embodiments, the ECU transmits the altered AC signal to a load when a sequence of one or more delays is present is a series of cycles of the AC signal.

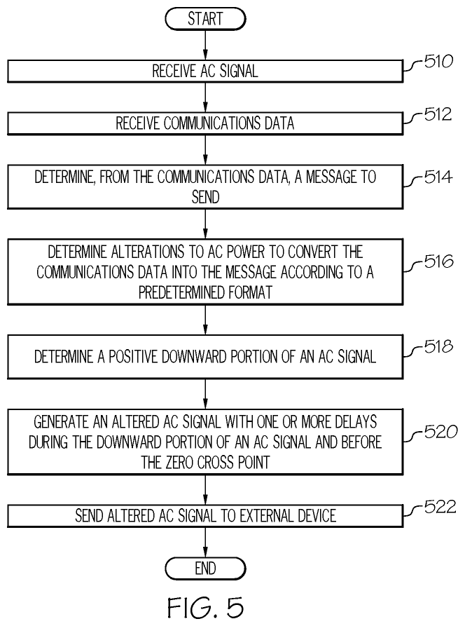

FIG. 5 depicts a flowchart for generating and sending altered AC power with a first device to a second device, according to embodiments described herein. As illustrated in block 510, AC power may be received from a power generation facility or other power source. In block 512, communication data may be received. As discussed above, the communication data may be received from a remote computing device 108 and/or via other source. Regardless, in block 514, a message for sending to a remote device may be determined from the communication data by the signal generator 104 (FIG. 1). In block 516, alterations to the AC signal may be determined to convert the communications data into the message according to a predetermined format. In block 518, a downward portion of a positive half cycle of the AC signal may be determined. In block 520, the AC signal may be altered by generating an altered AC signal with one or more delays during the downward portion of a positive half cycle of the AC signal and before the zero cross point of one or more cycles of the AC signal. In block 522, the altered AC signal may be sent to an external device.

FIG. 6 depicts a flowchart for determining contents of a message that was sent via altered AC signal and controlling the load device based on the action determined from the contents of the message, according to embodiments described herein. Moreover, in some embodiments, the controller may detect and remove or reduce potentially damaging delays within the altered AC signal. That is, the controller 112 may determine the location and duration of a delay within an altered AC signal and based on that location and/or duration of the delay cause a power unit 408 to introduce a voltage within the altered AC signal before or while the altered AC signal is transmitted to the load so that the negative impact of an excessively long delay or potentially damaging influx of voltage or current to the load may be reduced or eliminated. The flowchart depicted in FIG. 6 provides one example of a process executed by a controller 112 or a device 106 through a memory component 740 and a processor 730 for determining an action to perform that was sent via altered AC signal, conditioning the altered AC signal, and controlling the load device based on the action determined from the contents of the message.

As illustrated in block 610, an altered AC signal may be received by a device 106, for example, at the controller 112 of a device 106. The altered AC signal includes a message embedded within the AC signal by means of one or more delays introduced by a sending device, for example, a first device as described herein. In block 612, AC filters 414, analog to digital convertors or the like may be used to detect and convert the one or more delays into a computer-readable formatted data stream. An example of the computer-readable formatted data stream is depicted in FIG. 3B. In block 614, the controller 112 decrypts the series of one or more delays using a communication protocol. For example, as described herein a communication protocol may be based on the length of the one or more delays, the location of the delay within the AC cycle, the presence and absence of delays in successive cycles translating to binary values or characters, or the like. It should be understood that numerous communication protocols maybe implemented by introducing one or more delays within an AC signal. The AC signal provides, being cyclical in nature, provides the opportunity to exploit the repetitive timing of the cycles, locations within the cycles, and the length of delays which can further be identified by a controller through the predefined frequency of the cycles defining the AC signal.

While an action is being determined, which may take one or more cycles of the altered AC signal to determine as the message may span multiple cycles, the controller 112 optionally in combination with additional circuit components of the device 106 such as the power unit 408 determines whether the one or more delays present within a portion of the altered AC signal is a rising type delay 330 at block 616. That is, the controller 112 is configured to detect and remove or reduce the effect of rising type delays 330 in the altered AC signal before the altered AC signal is introduced to the load device. This further prevents or at least reduces the negative impacts of the one or more delays on the load device. When a rising type delays 330 is determined to be present in the altered AC signal, “YES,” at block 616, the controller 112, at block 618, causes the power unit 408 to introduce voltage during the rising portion delay of the altered AC signal transforming that portion of the altered AC signal into a conditioned power signal 322. The conditioned power signal 322 may be a linearly or sinusoidal wave of increasing voltage from the voltage level at which the delay started and terminate when the delay is determined to end. That is, the power unit 408, by discharging a capacitor, battery, or other power storage source and optionally inverter circuitry or the like may approximate the AC signal that is absent in the altered AC signal because of the delay introduced to form the message sent from the first device to the second device (e.g., the lighting device 106).

In some embodiments, the controller 112 may proceed with sending the altered AC signal and/or the conditioned power signal to the load based on the action determined from the message at block 624, if the controller 112 is not programed or further configured to also remove other types of delays from altered AC signal. That is, when “NO” is determined at block 620. Additionally, referring briefly back to block 616, when a rising type delays 330 is determined to not be present in the altered AC signal, “NO,” at block 616, the controller 112 proceeds to block 620. In embodiments where the controller 112 is programed or further configured to also remove other types of delays from altered AC signal, for example, “YES” at block 620, the controller 112, proceeds to block 622. At block 622, the controller 112, causes the power unit 408 to introduce voltage during the one or more delays in the downward portion of the altered AC signal transforming that portion of the altered AC signal into a conditioned power signal 322. The controller 112 then proceeds with sending the altered AC signal and/or the conditioned power signal to the load based on the action determined from the message at block 624.

In some embodiments, the determined message may include an action to provide power (e.g., AC power) to a load device at a predefined value. For example, the action may to cause the load device, which may be a light to dim, turn off, turn on, change color or the like. Accordingly, at block 618, the controller may cause the power unit 408 to condition to altered AC signal and send the conditioned power to the load 404 based on the determined action. It should be understood that the process depicted in the flowchart of FIG. 6 may be repeated in a continuous loop as additional cycles of the altered AC signal are received by the device 106 for controlling and powering a load 404.

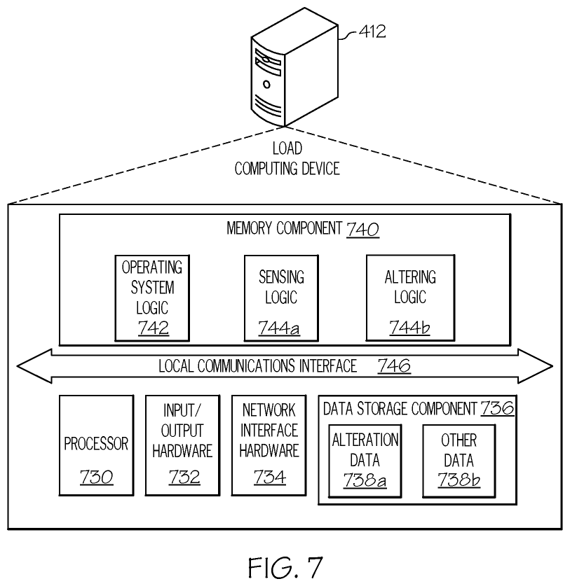

FIG. 7 depicts a load computing device 412 for determining a characteristic of AC power, according to embodiments described herein. The load computing device 412 includes a processor 730, input/output hardware 732, network interface hardware 734, a data storage component 736 (which stores alteration data 738a, other data 738b, and/or other data), and the memory component 740. The memory component 740 may be configured as volatile and/or nonvolatile memory and as such, may include random access memory (including SRAM, DRAM, and/or other types of RAM), flash memory, electrical erasable programmed read only memory (EEPROM), secure digital (SD) memory, registers, compact discs (CD), digital versatile discs (DVD), and/or other types of non-transitory computer-readable mediums. Depending on the particular embodiment, these non-transitory computer-readable mediums may reside within the load computing device 412 and/or external to the load computing device 412.

The memory component 740 may store operating system logic 742, sensing logic 744a and altering logic 744b. The sensing logic 744a and the altering logic 744b may each include a plurality of different pieces of logic, each of which may be embodied as a computer program, firmware, and/or hardware, as an example. A local interface 746 is also included in FIG. 7 and may be implemented as a bus or other communication interface to facilitate communication among the components of the load computing device 412.

The processor 730 may include any processing component operable to receive and execute instructions (such as from a data storage component 736 and/or the memory component 140). As described above, the input/output hardware 732 may include and/or be configured to interface with the components of FIG. 7.

The network interface hardware 734 may include and/or be configured for communicating with any wired or wireless networking hardware, including an antenna, a modem, a LAN port, wireless fidelity (Wi-Fi) card, WiMax card, mobile communications hardware, and/or other hardware for communicating with other networks and/or devices. From this connection, communication may be facilitated between the load computing device 412 and other computing devices, such as those depicted in FIG. 1.

The operating system logic 742 may include an operating system and/or other software for managing components of the load computing device 412. As discussed above, the sensing logic 744a may reside in the memory component 740 and may be configured to cause the processor 730 to determine voltage values, delays in power signal waveforms, as well as perform other functions, as described above. Similarly, the altering logic 744b may be utilized to provide instructions for altering one or more functions of the lighting device 106.

It should be understood that while the components in FIG. 7 are illustrated as residing within the load computing device 412, this is merely an example. In some embodiments, one or more of the components may reside external to the load computing device 412. It should also be understood that, while the load computing device 412 is illustrated as a single device, this is also merely an example. Similarly, some embodiments may be configured with the sensing logic 744a and the altering logic 744b residing on different computing devices. Additionally, while the load computing device 412 is illustrated with the sensing logic 744a and the altering logic 744b as separate logical components, this is also an example. In some embodiments, a single piece of logic may cause the remote computing device 108 to provide the described functionality or multiple different pieces may provide this functionality.

It should also be understood that while the load computing device 412 is depicted in FIG. 7, other computing devices, such as the AC controller computing device 204 and the remote computing device 108 may also include at least a portion of the hardware described with regard to FIG. 7. The hardware and software for these devices however, may vary from those described with regard to FIG. 7 to provide the desired functionality.

As illustrated above, various embodiments for implementing one or more delays corresponding to a coded communication in a downward cycle of an AC signal to control the operation of a load device. These embodiments may be configured to provide a user to with the ability to control output of a load (such as a lighting device) with a remote computing device. Embodiments also provide for circuitry that reduces or eliminates damage to a load device caused by instantaneous spikes in voltage due to delays implemented in AC signals used for communication and power to a load device. As such, embodiments may also provide the ability to communicate over AC power using the same frequency as the AC power.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

What is claimed is:

1. A system utilizing one or more delays in downward cycles of an alternating current power signal to control the operation of a load device, the system comprising:
a controller comprising a load computing device and a power unit, the controller being electrically coupled to the load device, and wherein the controller is configured to:
receive an altered AC signal, the altered AC signal comprising one or more delays within an alternating current (AC) signal during a downward portion of a positive half cycle of the AC signal,
determine, at the load computing device, a message from the one or more delays within the altered AC signal,
determine an action to execute based on the message,
determine whether the one or more delays present within a portion of the altered AC signal include a rising type delay,
in response to determining the presence of the rising type delay in the altered AC signal, cause the power unit to introduce voltage within the altered AC signal transforming the portion of the altered AC signal including the rising type delay into a conditioned power signal, wherein the conditioned power signal reduces the rising type delay, and
transmit the altered AC signal or the conditioned power signal to the load device based on the action determined from the message.

2. The system of claim 1, wherein the controller is further configured to:
determine the downward portion of the positive half cycle having the one or more delays,
cause the power unit to introduce voltage within the altered AC signal during the downward portion of the altered AC signal thereby transforming the portion of the altered AC signal into the conditioned power signal, wherein the conditioned power signal reduces the one or more delays, and
transmit the conditioned power signal to the load device based on the action determined from the message.

3. The system of claim 1, wherein the AC signal is a rectified AC signal.

4. The system of claim 1, wherein introduction of the one or more delays within the AC signal are based on a predetermined communication protocol.

5. The system of claim 4, wherein the predetermined communication protocol includes inserting a standard delay time at predetermined intervals in the AC signal, wherein based on the timing of the one or more delays, the controller may decode the message.

6. The system of claim 4, wherein the predetermined communication protocol includes coding the message by configuring a different predetermined lengths of delay to encode a character or a control command corresponding to a predetermined length of delay.

7. The system of claim 1, wherein the power unit comprises a power storage device comprising at least one of a battery or a capacitor for conditioning the altered AC signal.

8. The system of claim 1, wherein the load device includes a lighting device.

9. A method of utilizing one or more delays in downward cycles of an alternating current power signal to control the operation of a load device, the method comprising:
receiving, with a second device, an altered AC signal;
determining, with the second device, a message from the one or more delays within the altered AC signal;
determining, with the second device, an action to execute based on the message;
determining, with the second device, whether the one or more delays present within a portion of the altered AC signal include a rising type delay;
in response to determining the presence of the rising type delay in the altered AC signal, causing a power unit to introduce voltage within the altered AC signal transforming the portion of the altered AC signal including the rising type delay into a conditioned power signal, wherein the conditioned power signal reduces the rising type delay; and
transmitting the altered AC signal or the conditioned power signal to the load device based on the action determined from the message.

10. The method of claim 9, further comprising:
selectively introducing, with a first device, the one or more delays within an alternating current (AC) signal during a downward portion of a positive half cycle of the AC signal thereby generating the altered AC signal; and
transmitting, with the first device, the altered AC signal to the second device.

11. The method of claim 9, further comprising:
determining a downward portion of a positive half cycle having the one or more delays;
causing the power unit to introduce voltage within the altered AC signal during the downward portion of the altered AC signal thereby transforming the portion of the altered AC signal into the conditioned power signal, wherein the conditioned power signal reduces the one or more delays; and
transmitting the conditioned power signal to the load device based on the action determined from the message.

12. The method of claim 9, wherein introduction of the one or more delays within the AC signal is based on a predetermined communication protocol.

13. The method of claim 12, wherein the predetermined communication protocol includes inserting a standard delay time at predetermined intervals in the AC signal, wherein based on the timing of the one or more delays, the second device may decode the message.

14. The method of claim 12, wherein the predetermined communication protocol includes coding the message by configuring a different predetermined length for the one or more delays to encode a character or a control command corresponding to a predetermined length of delay.

15. The method of claim 9, wherein the power unit of the second device comprises a power storage device comprising at least one of a battery or a capacitor for conditioning the altered AC signal.

16. The method of claim 15, wherein the load device includes a lighting device.

17. A device for providing delaying a downward cycle of an alternating current power signal to control the operation of a load device, the device comprising:
a processor;
a memory component includes logic that, when executed by the processor, causes the device to:
receive an altered AC signal, the altered AC signal comprising one or more delays within an alternating current (AC) signal during a downward portion of a positive half cycle of the AC signal,
determine, at the load computing device, a message from the one or more delays within the altered AC signal,
determine an action to execute based on the message,
determine whether the one or more delays present within a portion of the altered AC signal include a rising type delay,
in response to determining the presence of the rising type delay in the altered AC signal, cause a power unit to introduce voltage within the altered AC signal transforming the portion of the altered AC signal including the rising type delay into a conditioned power signal, wherein the conditioned power signal reduces the rising type delay, and
transmit the altered AC signal or the conditioned power signal to the load device based on the action determined from the message.

18. The device of claim 17, wherein the memory component includes logic that, when executed by the processor, further causes the device to:
determine the downward portion of the positive half cycle having the one or more delays;
cause the power unit to introduce voltage within the altered AC signal during the downward portion of the altered AC signal thereby transforming the portion of the altered AC signal into the conditioned power signal, wherein the conditioned power signal reduces the one or more delays; and
transmit the conditioned power signal to the load device based on the action determined from the message.

19. The device of claim 17, wherein the alternating current (AC) signal is a rectified AC signal.

20. The device of claim 17, wherein introduction of the one or more delays within the AC signal is based on a predetermined communication protocol, wherein the predetermined communication protocol includes coding the message by configuring a different predetermined length for the one or more delays to encode a character or a control command corresponding to a predetermined length of delay.
